(19) United States
(12) Patent Application Publication
(10) Pub. No.: US 2026/0119172 A1
(43) Pub. Date: Apr. 30, 2026

(54) GATHER ACCELERATED ADDRESS SPACE

(71) Applicant: NVIDIA Corporation, Santa Clara, CA (US)

(72) Inventors: Donghyuk Lee, Cedar Park, TX (US); James Michael O"Connor, Austin, TX (US); David Nellans, Round Rock, TX (US); Niladrish Chatterjee, Kirkland, WA (US)

(21) Appl. No.: 18/926,133

(22) Filed: Oct. 24, 2024

(51) Int. Cl. G06F 9/30; G06F 9/38; G06F 9/50

(52) U.S. Cl. CPC G06F 9/3004; G06F 9/30036; G06F 9/30043; G06F 9/345; G06F 9/3887; G06F 15/8007

(57) ABSTRACT

In a system including a processing unit and a set of one or more stacked memory chips, the processing unit can request data. When the data is distributed such that there is at least one non-contiguous memory sector in the smallest unit of memory segments usable by the system, then a gather operation can be utilized to instruct the set of one or more stacked memory chips to gather the requested data into a virtual address space, e.g., a gather accelerated address space. The requested data can be aligned to the byte chunk size used by the processing unit and at least some of the unneeded memory segments can be skipped, e.g., not copied into the virtual address space. The requested data in the virtual address space can be communicated to the processing unit using less bandwidth resources than when not using the gather operation.

### STATEMENT OF GOVERNMENT INTEREST

This invention was made with U.S. Government support under SNL prime contract DE-NA0003525 (Advanced Memory Technology) awarded by DOE. The U.S. Government has certain rights in this invention.

### TECHNICAL FIELD

This application is directed, in general, to computer memory requests and, more specifically, to optimizing memory data requests.

### BACKGROUND

Processing units, such as graphics processing units, often need to retrieve data from a memory location that is not on the processing unit chip, e.g., not L1 or L2 cache. These requests for data use a data channel that connects the processing unit and memory chips. The memory chips can be stacked and include a base layer to provide operational control of the stacked memory chips. The requested data from the stacked memory chips may not be in contiguous memory sectors of the memory chips. There can be data elements that are not needed to satisfy the requested data request. Sending these unneeded data elements because they are between two other needed data elements is not an efficient use of the bandwidth of the data channel connection between the stacked memory chips and the processing unit. It would be beneficial to optimize the requested data to improve the bandwidth communication of the requested data from the stacked memory chips to the processing unit.

### BRIEF DESCRIPTION

Reference is now made to the following descriptions taken in conjunction with the accompanying drawings, in which:

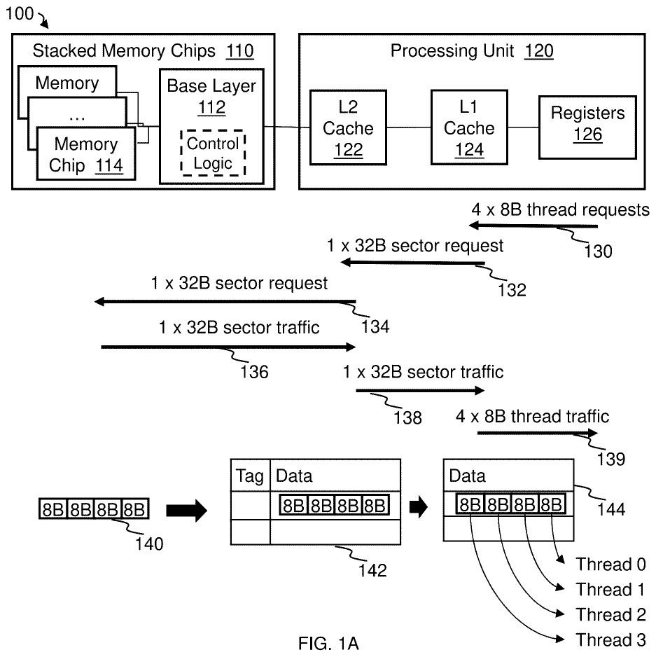

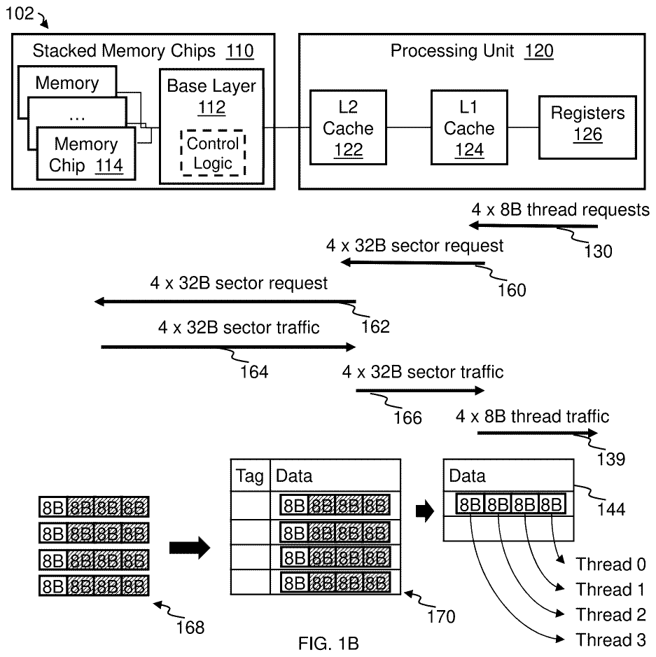

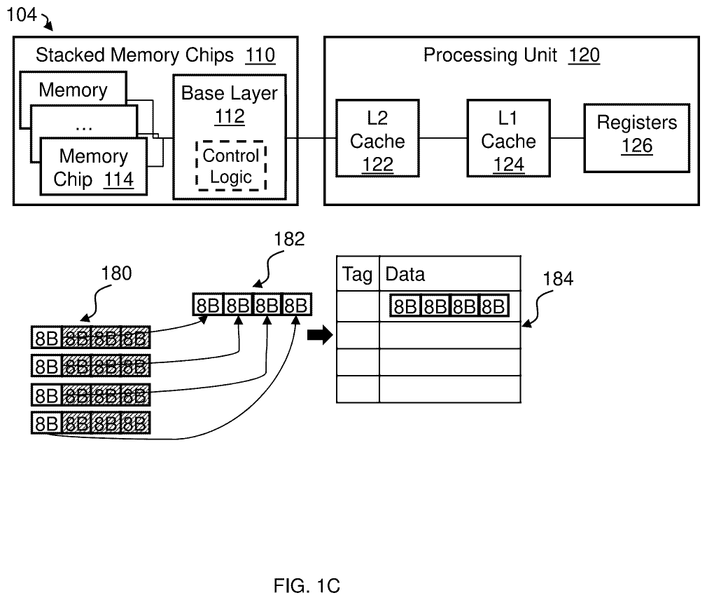

FIG. 1A is an illustration of a diagram of an example processing system;

FIG. 1B is an illustration of a diagram of an example processing system with data inefficiency;

FIG. 1C is an illustration of a diagram of an example processing system using a gather accelerated address space;

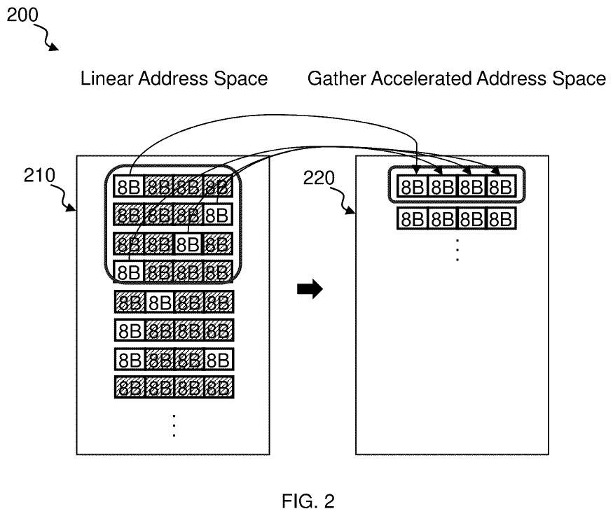

FIG. 2 is an illustration of a diagram of an example mapping to a gather accelerated address space;

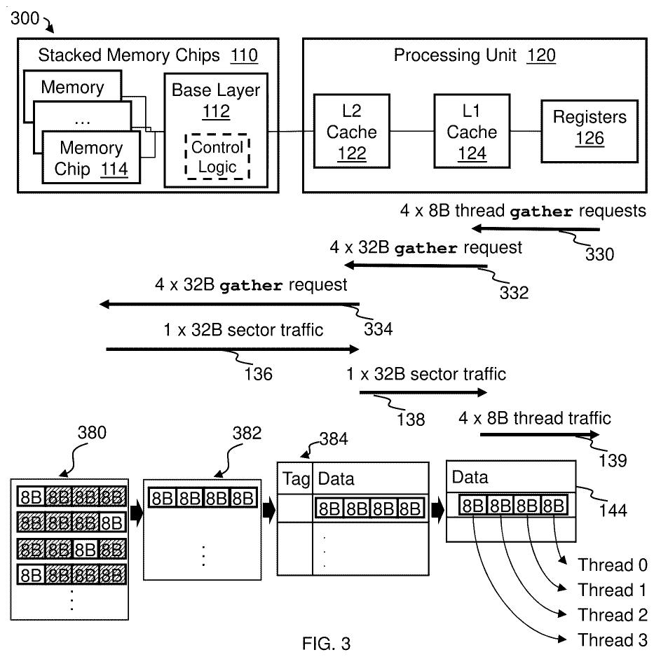

FIG. 3 is an illustration of a diagram of an example processing system using a gather accelerated address space implemented in multiple stacks of memory chips;

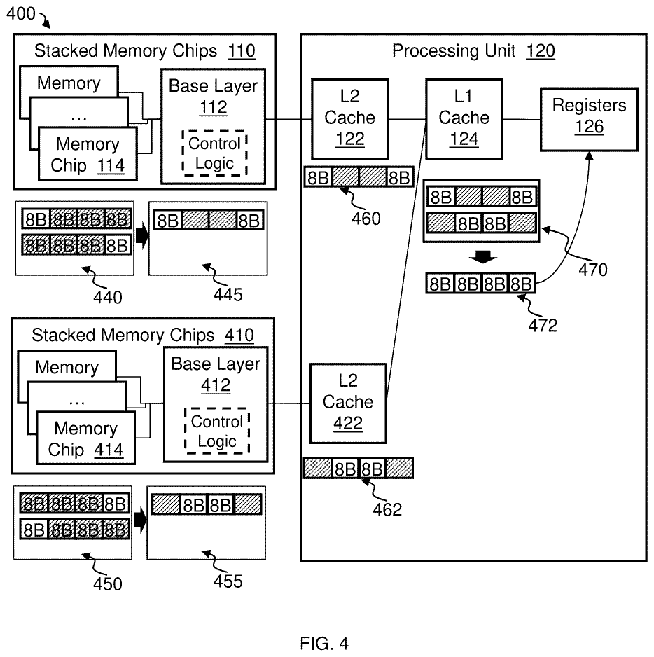

FIG. 4 is an illustration of a diagram of an example processing system using a gather accelerated address space that merges partially gathered data from multiple stacks of memory chips;

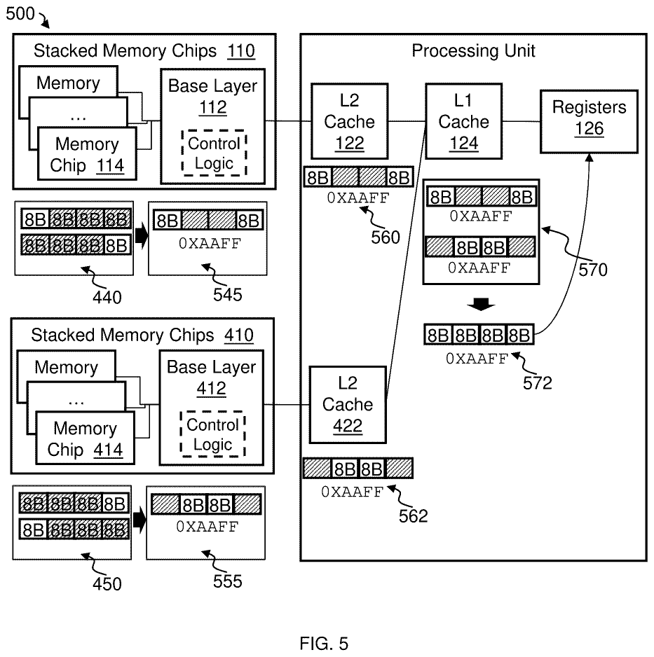

FIG. 5 is an illustration of a diagram of an example processing system using per-stack local address spaces;

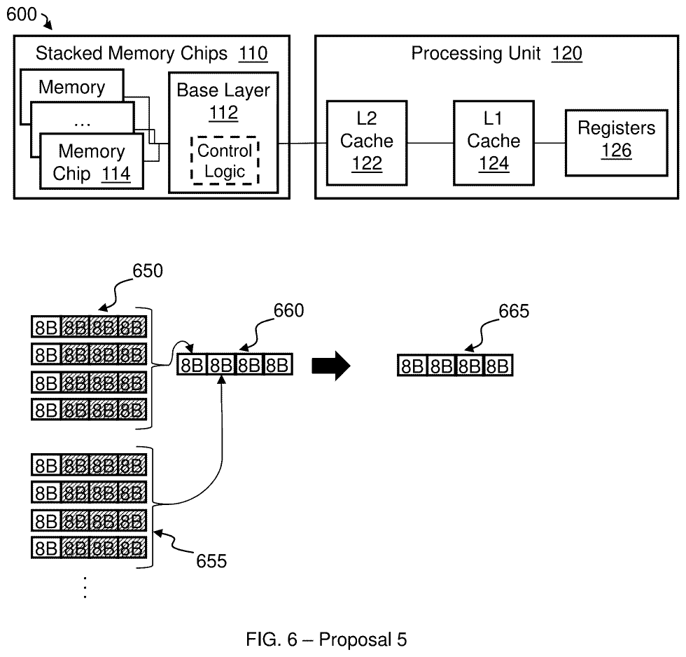

FIG. 6 is an illustration of a diagram of an example gather accelerated address space using an algorithmic combination; and

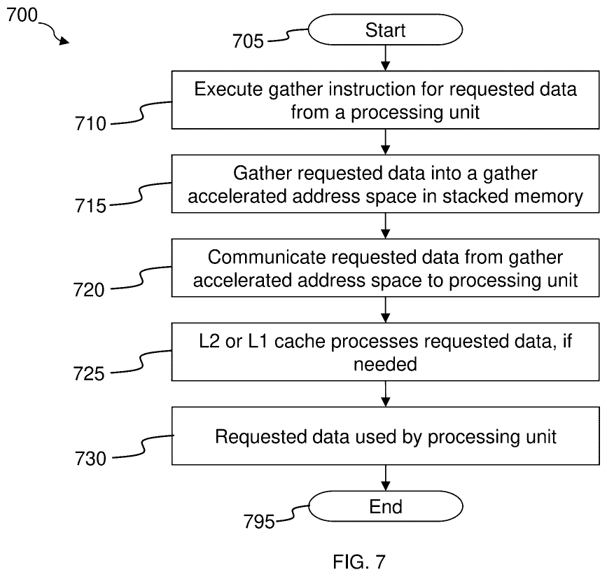

FIG. 7 is an illustration of a flow diagram of an example gather operation.

### DETAILED DESCRIPTION

Processing units, such as graphics processing units (GPUs), central processing units (CPUs), single instruction multiple data processing units (SIMD), or other types of processing units, often need to request data from a memory source external to the processing unit. Typically, this is one or more memory chips that are communicatively coupled to the processing unit. For example, a memory chip located on the same circuit board as the processing unit. As the memory chips have progressed in complexity, for example, implementing stacked memory chips, e.g., stacked dynamic random-access memory (DRAM), the memory chips have implemented operational control layers (control logic) to manage the stacked memory chips, e.g., implemented in a base layer. The communication bandwidth within the stacked memory chips can be greater than the bandwidth available for communicating between the stacked memory chips and the processing unit. For example, the operational control layer can have a bandwidth that is two to three times greater than the bandwidth between the stacked memory chips and the processing unit.

Memory is typically accessed as a pre-defined data size. For example, DRAM in modern GPU systems can be accessed as a chunk of 32-Bytes of consecutive data. In an example system with sectored cache, four 32 Byte memory sectors form a 128-Byte cache line, such that a 32 Byte sector is the minimum data management granularity in this system. Upon request of the processing unit, the operational control logic, e.g., as implemented by the base layer, of the stacked memory chips can retrieve the requested data from one or more memory sectors. The control logic can be implemented using software, hardware circuitry, or a combination thereof. Typically, the control logic directs operation of the memory chips and provides communication with other system resources. The control logic can be a single circuit or multiple circuits.

This data can then be communicated to the processing unit across the data channel. The requested data may not align with the specified memory sector sizes. For example, the data may be located across multiple memory sectors where each memory sector is not full. Communicating the unneeded memory locations within these memory sectors can use the available bandwidth between the memory chips and the processing unit, such that the processing unit can be forced to wait for additional processing cycles to receive the requested data.

Previous solutions to improving the data communication in data channels across the memory chips and processing units have utilized data compression. Other solutions have utilized integrating higher frequency and lower voltage interfaces between the memory chips and the processing units.

This disclosure presents an approach to gather useful data (requested data elements) from the stacked memory chips, while avoiding the unneeded memory elements by leveraging application characteristics of data access patterns. The approach can reduce the data traffic on the stacked memory chip and processing unit interface. Gathering useful data and managing the data in a gathered form can reduce bandwidth consumption and result in using a smaller amount of the on-processing unit caches. In some aspects, the disclosed approach can be combined with the previous conventional approaches for improving bandwidth efficiency.

The disclosed approach can be implemented, for example, by using a gather operation, comprising one or more gather instructions. The gather operation can gather small (for example, less than 32 Bytes (B)) data elements within the stacked memory chips, re-organize them using the control logic, and then communicate the requested data to the processing unit. In some aspects, the control logic can include a gather operation unit. The gather operation unit can include the logic that performs the gathering operation and responds to requests associated with the gather address space.

In some aspects, the re-organization can use a specified byte addressing and chunk sizing expected by the processing unit, for example, 8B address chunks. The byte chunk size can specify how the smaller data elements are aligned to form the larger data element chunks expected by the processing unit (such as 32B data chunks). A gather operation can pack a certain number of elements together in a result footprint of the gather accelerated address space. For example, a GPU with a warp size of 32 threads may issue a gather operation that will pack 32 elements together. If the elements are 8B elements, this will produce a result in the gathered address space of 32*8B=256B. If the gather operation specifies that the elements are 4B, for instance, then the result will be 32*4B=128B.

The byte chunk size is the minimum granularity that the gather accelerated address space uses, and can be the boundary on which it should be aligned in the address space. In some aspects, since the smallest element is likely to be 1B, the smallest amount of gather accelerated address space consumed by a result is 32B. In various systems, the byte chunk size can be of different sizes.

The gather accelerated address space is programmer defined memory location that stores data elements in a programmer defined order, such that, after gathering data elements, further requests to the gather accelerated address space can be delivered as a gathered form efficiently. In some aspects, the gather accelerated address space can be an alternate virtual address space located in the stacked memory chips. The gather operation can be utilized to establish a gather accelerated address space. The gather operation can perform small-data gathers (e.g., where small data is less than the memory chunk size used by the processing unit, for example, 32B sector size) by copying data from the conventional linear address space into the gather accelerated address space. This procedure can occur within the stacked memory chips, thereby taking advantage of reducing communication bandwidth consumption in the interfaces between the stacked memory chips and the processing units.

In some aspects, the gather accelerated address space can be backed with physical memory to maintain compatibility with the on-chip cache hierarchy while not introducing consistency issues. The requested data is first gathered and stored in a new address in the gather accelerated address space. Then, using the new address, the gathered data can be communicated to the processing unit and stored in the caches on the processing unit. Since unneeded data sectors are not stored in the gather accelerated address space, the requested data can be communicated using fewer compute cycles thereby allowing the system to perceive an increase in overall performance and throughout.

Turning now to the figures, FIG. 1A is an illustration of a diagram of an example processing system 100. Processing system 100 can be located on one or more circuit boards. Improvements in stacking technology can enable high bandwidth with the stacked memory chips. In some aspects, a 2.5-dimensional (D) stacked system can be utilized. This means that the 3D stacked memory chips can be attached over a horizontal chip-to-chip interface with the processing unit. The potential peak bandwidth in the vertical memory chip interface within the stacked memory chips can be significantly higher in bandwidth than the stacked memory chip to processing unit interface, e.g., the data channel. For example, the stacked memory chips can utilize a bandwidth that is three times greater than the bandwidth available between the stacked memory chip and the processing unit. The limited interface communication bandwidth can lead to the stacked memory chip bandwidth being underutilized, e.g., the potential peak bandwidth in the stacked memory chip is not leveraged.

Processing system 100 includes a set of one or more stacked memory chips 110 (e.g., a memory apparatus) communicatively coupled to a processing unit 120 (e.g., a processing unit apparatus). Stacked memory chips 110 can include two or more memory chips 114, such as DRAM or other types of memory chips. Stacked memory chips 110 includes a base layer 112 capable of including control logic providing operation control of the memory chips and providing an interface for communication to other chips in the system, such as processing unit 120.

Processing unit 120 can be a GPU, CPU, SIMD, or other type of processing unit. Processing unit 120 typically includes, but does not need to include, an L2 cache 122 and an L1 cache 124. Processing unit 120 includes a set of registers 126, such as part of a streaming multiprocessor (SM).

Processing system 100 demonstrates one type of request for requested data using a size of 8B data elements and 32B memory sectors for communicating data within processing unit 120 and communicating with stacked memory chips 110. A request for requested data can be initiated by processing unit 120 (e.g., through an SM included with the processing unit 120) through the execution of commands using set of registers 126. In this demonstration aspect, four thread requests each with 8B of data are requested at process 130. In some aspects, the thread can access the granularity of data that is smaller than, larger than, or equal to 8B. Process 130 flows to L1 cache 124 and on to L2 cache 122 using a combined 32B memory sector request at process 132 after translating the thread requests into multiple sector requests. Process 132 can proceed to L2 cache 122 when the requested data is not hit on or available at L1 cache 124. Process 132 can proceed to base layer 112 when the requested data is not available in L2 cache 122.

From L2 cache 122 to base layer 112, the request arrives as one 32B memory sector at process 134. Base layer 112 retrieves the appropriate requested data from memory chips 114 and communicates the data back to L2 cache 122 using process 136 which is one 32B sector traffic. L2 cache 122 to L1 cache 124 flows using process 138 which is one 32B sector traffic. L1 cache 124 communicates the requested data to set of registers 126 using four 8B data traffic flow at process 139.

Process 136 is demonstrated as one 32B memory sector 140 that consists of four 8B data elements. Memory chips 114, in this example, can access 32B granularity of data. Process 142 is demonstrated as one 32B sector stored in L2 cache 122, which can be accessed with tag lookup. Process 138 demonstrates the communication of the data block from L2 cache 122 to L1 cache 124. Process 139 is demonstrated as four 8B data elements from one 32B memory sector (stored in L1 cache 124), where each 8B memory sector is communicated to a different respective processing thread at process 144. Threads that are accessing a linear region of address space utilize a request and response that are the same, e.g., 32B, and aligned to memory chips 114 access granularity of 32B. Processing system 100 demonstrates one possible flow with a selected size of memory sectors (32B). Other processing systems can utilize different memory sector sizes depending on the processing unit being used, the memory chips being used, and the available communications channel bandwidth between the memory chips and the processing unit.

FIG. 1B is an illustration of a diagram of an example processing system 102 with data inefficiency. Processing system 102 is similar to processing system 100, where processing system 102 demonstrates data inefficiency when retrieving requested data. When requested data is not stored linearly in memory chips 114, 32B sectors that include the requested data can include unneeded data. When this unneeded data is communicated, it uses communication bandwidth that could be otherwise used by other needed data. Processing system 102 shows that memory chips 114 allow access as 32B sectors, such that, even if some of the data in the accessed 32B sectors is not needed, the entire 32B sectors are delivered.

Process 132 is replaced by a process 160 which uses four 32B memory sector requests since the requested data is distributed across different 32B linear sectors. Process 134 is replaced by a process 162 which uses four 32B memory sector requests since the requested data is distributed across different 32B linear sectors. The respective sectors are shown in process 168 which has four memory sectors, where one 8B data elements within each 32B memory sector contains data needed for the requested data. Process 136 is replaced by a process 164 which communicates the four 32B sector traffic from stacked memory chips 110 to processing unit 120. This is 128B of data being communicated, even though 32B of this data is needed. This is shown in a process 164 and 166, visually organized as shown in process 170. L1 cache 124 stores four 32B sectors while a set of registers 126 remains the same, as shown in process 144. The memory sector and memory traffic sizes shown here are for demonstration purposes and different processing systems can utilize different memory sector and memory traffic sizes. Processing system 102 demonstrates an inefficiency in the communications bandwidth that can be resolved with this disclosure.

FIG. 1C is an illustration of a diagram of an example processing system 104 using a gather accelerated address space. Processing system 104 is similar to processing system 100 and processing system 102. Processing system 104 implements the gathering operation within stacked memory chips 110 to reduce the amount of unneeded data being communicated to processing unit 120. The gathering operation translates linear address space to the gather accelerated address space, which builds data structures stored in the gather accelerated address space.

Process 180 is similar to process 166 that four 32B memory sectors are gathered since each 32B memory sector contains some of the requested data. Process 182 implements the gathering operation that loads 32B memory sectors from the linear address space and store useful 8B data elements to the memory location in the gather accelerated address space. In some aspects, the memory location of the gather accelerated address space is specified by programmer, which can be a part of generic virtual address space backed by physical address space. In some aspects, process 182 can be implemented by base layer 112 and its respective control logic. The implementation can leverage the high bandwidth in stacked memory chips 110 to gather requested small, i.e., less than 32B sized data elements within stacked memory chips 110, re-organize the data elements, and store them in the virtual address space. The requested data is now in one 32B alignment to be communicated to processing unit 120 as shown in process 184. The communication of one 32B memory traffic is significantly lower than the 128B memory traffic demonstrated in processing system 102.

In some aspects, the virtual gather accelerated address space can be sized such that the chunks of data stored match the sizing of the chunks of data expected by the processing unit, for example, a processing unit can be expecting 8B chunks in a larger 32B chunk of data. Similar to processing system 100 and processing system 102, memory sector and memory traffic sizes are presented here for demonstration purposes, and other sizes can be used.

The physical SRAM size that maps to the gather address space size is not strictly related to the DRAM bandwidth or capacity. The size of the gather accelerated address space buffers should be large enough to map in-flight gather requests from the moment they are launched until they are returned to the GPU. Thus, there is a minimum size for maximum peak performance that is proportional to the bandwidth and latency of the DRAM stacks. In some aspects, the gather accelerated address space can be larger than the physical buffer capacity. In some aspects, similar to conventional virtual-to-physical address translation that can map a larger virtual address space to a smaller number of physical memory pages, a larger gather accelerated address space can potentially be mapped to a smaller set of physical gather accelerated buffers. In some aspects, for example, this can be accomplished by having a cudaMalloc_gather( ) call allocating a portion of the physical buffer and mapping it to the associated virtual gather accelerated address space range.

In some aspects, the cudaMalloc_gather( ) call reserves a portion of the regular virtual address space to be used for gather accelerated instructions. Physical memory does not need to be specifically associated with these virtual addresses. The physical gather accelerated buffers used to accumulate the gather accelerated operations can be dynamically allocated, in a similar way as data lines in a cache are allocated to specific addresses as they are referenced. Those skilled in the art will appreciate that there are trade-offs with respect to flexibility, tag-check, or memory management unit (MMU) overheads and performance that can affect the preference for one aspect over another.

FIG. 2 is an illustration of a diagram of an example mapping 200 to a gather accelerated address space. Mapping 200 demonstrates and example of how requested data can be stored in linear address space 210. Four 32B memory sectors are shown, each with one 8B of needed data located within the linear address space. When the gather operation is performed within the stacked memory chips, the needed 8B memory sectors from each of the 32B memory sectors are copied into the memory location that is specified as the gather accelerated address space by a programmer. Gather accelerated address space can be part of virtual memory space backed by physical memory which can help maintain compatibility with the on-chip cache hierarchy while not introducing consistency issues. In some aspects, the one or more gather instructions used to implement the gather operation can be executed asynchronously as to not block other instructions from issuing. In some aspects, the one or more gather instructions and other instructions can be synchronized using memory fence or memory barrier techniques.

In some aspects, the gather operation can be performed by the control logic in the stacked memory chips. In some aspects, parameters for the gather operation can be communicated from the processing unit. In some aspects, the parameters for the gather operation can be specified by a user through the code being executed. In some aspects, the parameters for the gather operation can be specified by the processing unit, such as in ROM, operating instructions, or code libraries.

An example pseudocode for accessing linear address space 210 without this disclosure is shown in code listing 1. An example pseudocode for accessing gather accelerated address space 220 using this disclosure is shown in code listing 2. In code listing 2, memory space with pointer &gather was allocated, which is transferred to kernel_with_gather( ) and used for storing data in the memory location in the gather accelerated address space. Combining two instructions in Code listing 2 (LOAD R1 [linear] and STORE [gather]) leads to the one or more gather instructions.

```
Code Listing 1: Example pseudocode for using traditional linear address spaces
_global_ void kernel_without_gather (*linear) {
LOAD R0 /* Load a register (register 0 in this example) */
...
XXXX R0 ... /* Perform an operation stored in a register (register 0 in this example) */
}
int main ( ) { /* Pseudocode for calling kernel_without_gather */
    cudaMalloc (&linear, size) /* memory allocation in linear address space */
    kernel_without_gather<<<1,1>>>(linear) /* call my_gather kernel */
}
Code Listing 2: Example pseudocode for enabling gather accelerated address spaces
_global_ void kernel_with_gather (*linear, *gather) {
  /* Load a register with a linear address space data */
STORE [gather] R1 /* Store the loaded data to gather accelerated address space*/
LOAD R0 [gather] /* Load a register with the data from the gather accelerated address
space */
...
XXXX R0 ... /* Perform an operation stored in a register */
}
int main ( ) { /* Pseudocode for calling kernel_with_gather */
    cudaMalloc (&linear, size) /* memory allocation for linear address space */
cudaMalloc_gather (&gather, gather_size) /* memory allocation for gather accelerated
memory space */
    kernel_with_gather<<<1,1>>>(linear, gather)
}
```

FIG. 3 is an illustration of a diagram of an example processing system 300 using a gather accelerated address space implemented in stacked memory chips. Processing system 300 is similar to processing system 100, processing system 102, and processing system 104. Processing system 300 demonstrates that processing unit 120 changes in how it requests requested data using a gather operation.

Process 130 is replaced with a process 330 which is a four 8B thread gather request. The flow transforms into a four 32B gather request in process 332 (replacing process 160). Process 162 is replaced by process 334, using the same size sector addresses, but specifying that a gather operation is to be utilized. The four 32B memory sectors are gathered in process 380 and are mapped into the gather accelerated address space in process 382. The gathered 32B memory sector is communicated from stacked memory chips 110 to processing unit 120 in process 136. Process 384 is L2 cache 122 status storing the gathered data. Process 144 remains the same as the data is mapped to their respective threads for processing. Processing system 300 demonstrates how the gather operation can be executed entirely within stacked memory chips 110. The example demonstration as shown in processing system 300 shows that moving the requested data into a gather accelerated address space and then reading data from the gather accelerated address space for communication to the processing unit can result in four times reduction in an effective memory bandwidth compared to reading data from the conventional linear address space.

FIG. 4 is an illustration of a diagram of an example processing system 400 using a gather accelerated address space that merges partially gathered data from multiple stacks of memory chips. Processing system 400 is similar to processing systems 100, 102, 104, and 300. Processing system 400 demonstrates how the gather operation can be implemented when the requested data is located across more than one stacked memory chip. Each stacked memory chip is paired with an L2 cache area which then passes the requested data to the L1 cache where it is merged into a single address space for further processing by the requesting threads.

Stacked memory chips 110 gathers the requested data as shown in process 440 and gathers the requested data that resides within stacked memory chips 110 into the memory location in a gather accelerated address space in process 445. The gathered data is communicated to L2 cache 122 as shown in memory traffic 460. This is similar to the previous processing system 300. Processing system 400 has a second stacked memory chips 410 that includes memory chips 414 and a base layer 412. Stacked memory chips 410 includes another portion of the requested data and gathers the data in process 450 and then copies the data into the memory location in a gather accelerated address space in process 455. Process 445 and process 455 can gather the existing requested data in its respective stack and fill in zeros, blanks, nulls, or another character for requested data not existing in its respective stack. The gathered data is communicated to a L2 cache 422 as shown in memory traffic 462.

L2 cache 122 and L2 cache 422 communicate the respective data (memory traffic 460 and memory traffic 462) to L1 cache 124. At L1 cache 124, the respective partially gathered data can be merged in a process 470 to be transformed into memory traffic 472. Memory traffic 472 is then used and processed as described previously. Processing system 400 shows two stacked memory chips and two L2 caches. There can be three or more stacked memory chips each with an associated L2 cache area. Process 470 can merge two or more gathered address spaces as needed.

FIG. 5 is an illustration of a diagram of an example processing system 500 using per-stack local address spaces. Processing system 500 is similar to processing system 400 with the addition of specifying a per-stack local address space (e.g., separate memory stacks). Process 445 is replaced with a process 545 showing an example defined per-stack local address space. Process 455 is replaced with a process 555 showing the per-stack local address space in the second stacked memory chips 410. Each stack and its corresponding L2 cache can have its own respective per-stack local address. In some aspects, the same per-stack local address can exist in multiple stacks. The gather operation can be issued with a parameter indicating the per-stack local address to be used with each stacked memory chips. Similar to processing system 400, the partial gathered data can be communicated to L1 cache 124 where the requested data can be merged and reduced for the same per-stack local address.

Memory traffic 460 is replaced by a memory traffic 560 at L2 cache 122 to include the per-stack local address. Memory traffic 462 is replaced by a memory traffic 562 at L2 cache 422 to include the per-stack local address. Process 470 is replaced by a process 570 at L1 cache 124 to include the per-stack local address. In some aspects, the stacks using the same per-stack local address will be merged and reduced, resulting in memory traffic 572. Data processing continues as before.

In some aspects, there can be more than one stacked memory chip, each with one or more L2 caches. Each L2 cache can be associated with an SM. In these aspects, the gathered data can be stored in the stacked memory that corresponds to the SM that initialized the requested data, e.g., the physical memory backing up the per-stack local address that is being used. The SM can typically access the stacked memory chips in one or more of the stack slices when multiple SMs and multiple stacked memory chips are present. In some aspects, each stack slice can have its own memory stack. Storing the gathered data in the stacked memory chip corresponding to the SM would enable faster access to the data.

FIG. 6 is an illustration of a diagram of an example processing system 600 using an algorithmic combination. Processing system 600 is similar to processing systems 104, 300, 400, and 500. Processing system 600 includes an additional step to perform an algorithmic combination on the requested data to further reduce the memory sector size used by the requested data. By reducing the memory sector size to at least as small as the bandwidth of processing unit 120, more efficiency can be gained in the communication bandwidth between stacked memory chips 110 and processing unit 120. The gather algorithm to use can be specified in the parameters for the gather operation. The gather algorithm can be an addition algorithm, a multiplication algorithm, a compression algorithm, a transpose algorithm, a reduction algorithm, a filtering algorithm, a progressive sum algorithm, or other algorithms that can result in the reduction of the requested data into smaller memory sectors.

Processing step 650 and processing step 655 can gather the requested data as described previously. Each processing step 650 and 655 can apply the specified gather algorithm to reduce the requested data to a smaller data size. In this example, four 32B sets of data can be reduced to one 8B by combining the gather accelerated address space with a gather algorithm to combine data. The combined data can be communicated to processing unit 120. This example shows four 32B of data being reduced to four 8B of data and then combined to form one 32B of data that can be communicated across the data channel.

FIG. 7 is an illustration of a flow diagram of an example method 700 executing a gather operation. Method 700 can be performed on a computing system, for example, processing unit 120 or stacked memory chips 110. In some aspects, method 700 can be performed by a control logic of a base layer of memory chips 110. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 700 can be encapsulated in software code or in hardware, for example, an application, code library, code module, dynamic link library, module, function, RAM, ROM module, and other software and hardware implementations. The software can be stored in a file, database, or other computing system storage mechanism. Method 700 can be partially implemented in software and partially in hardware. Method 700 can perform the steps for the described processes, for example, gathering requested data into a virtual gather accelerated address space in the stacked memory chips and communicate the requested data from the gather address space to one or more processing units. In some aspects, the virtual gather accelerated address space can be located in the memory chips. In some aspects, the virtual gather accelerated address space can be located in the base layer.

Method 700 starts at a step 705 and proceeds to a step 710. In step 710, a gather operation can be issued by an SM of a processing unit. In some aspects the gather operation can include parameters to control the operation, for example, specifying a per-stack local address, a reduction or combination algorithm to use, or other instructions. In some aspects, the parameters of the gather operation can specify the element size (e.g., byte chunk size) to utilize, e.g., the optimum element size for the processing unit. The gather operation is communicated to one or more sets of stacked memory chips, where each set of one or more stacked memory chips contains at least two memory chips.

In a step 715, the requested data can be gathered into a gather accelerated address space. The use of the gather accelerated address space is needed when the requested data is stored in at least two non-contiguous byte segments (e.g., non-contiguous memory sectors). In aspects where the requested data is linearly contiguous, then the gather operation can be ignored and conventional data retrieval techniques can be used. The gather operation can be performed by the control logic of the base layer in each of the sets of stacked memory chips. The gather accelerated address space is a virtual address space backed by physical memory. As the requested data is copied into the gather accelerated address space, unneeded memory sectors are not copied.

In a step 720, the requested data in the gather accelerated address space can be communicated to the processing unit. Since at least some unneeded data sectors are not part of the transmission, the bandwidth is used more efficiently. The gather accelerated address space can be aligned to the byte chunk size expected by the processing unit so the data can be communicated and used efficiently. The transformation of the requested data from the memory sectors is performed by the control logic of the base layer of each set of one or more stacked memory chips.

In a step 725, the L2 cache or the L1 cache can perform processes on the requested data, if needed. In some aspects, for example, the L1 cache can perform a merge and reduce operation when requested data is received from more than one set of one or more stacked memory chips. This can occur when data is distributed across more than one set of one or more stacked memory chips and each set of one or more stacked memory chips communicates partially gathered requested data. In a step 730, the requested data, received by the processing unit can then be used as needed. Method 700 ends at a step 795.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic and/or features for performing a task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Aspects disclosed herein include:
A. A memory apparatus, including (1) a set of one or more stacked memory chips, containing at least two memory chips, and (2) a control logic, operable to direct operation of the set of one or more stacked memory chips and to communicate with at least one processing unit, copy requested data using a gather operation, requested by the at least one processing unit, from the set of one or more stacked memory chips to a gather accelerated address space, the requested data is communicated to the at least one processing unit using the gather accelerated address space, where the gather operation aligns the requested data to a byte chunk size expected by the at least one processing unit and copies at least two non-contiguous byte segments corresponding to the requested data.
B. A processing unit, including (1) a streaming multiprocessor (SM) operable to initiate a gather operation, (2) at least two L2 caches, wherein each L2 cache is communicatively coupled to a different memory stack, where each L2 cache receives requested data from a respective memory stack utilizing the gather operation, and the requested data is retrieved from at least two non-contiguous byte segments where zeros are used to fill non existing data in the requested data according to a byte chunk size, and (3) an L1 cache communicatively coupled to the at least two L2 caches and the SM, wherein the L1 cache merges the requested data received from each of the at least two L2 caches into a merged requested data and communicates the merged requested data to the SM.
C. A system, including (1) one or more memory stacks, wherein each of the one or more memory stacks have at least two memory chips and a control logic capable of directing operations of the memory stack, and (2) a processing unit communicatively coupled to the one or more memory stacks, capable of initiating a gather operation to at least one of the one or more memory stacks, wherein the gather operation informs the at least one of the one or more memory stacks to return requested data, the requested data is stored across more than one memory sector of the at least one of the one or more memory stacks, the requested data is mapped into a gather accelerated address space where non-contiguous memory sectors containing the requested data are mapped according to a byte chunk size, and the requested data is communicated to the processing unit from the gather accelerated address space.
D. A method, including (1) initiating a gather operation at a streaming multiprocessor (SM) for requested data, wherein the requested data is stored in at least two non-contiguous memory sectors of a set of one or more stacked memory chips, (2) receiving the gather operation at one or more sets of stacked memory chips, (3) gathering the requested data into a gather accelerated address space of the one or more sets of stacked memory chips, wherein the gather accelerated address space is a virtual address space backed by physical memory, and at least some unneeded memory sectors are not copied into the gather accelerated address space, (4) aligning the requested data in the gather accelerated address space according to a byte chunk size used by the SM, and (5) communicating the requested data to the SM.

Each of the disclosed aspects in A, B, C, and D can have one or more of the following additional elements in combination. Element 1: wherein the set of one or more stacked memory chips are dynamic random-access memory (DRAM) chips. Element 2: wherein the processing unit is a graphics processing unit (GPU), a central processing unit (CPU), or a single instruction, multiple data processing unit (SIMD). Element 3: wherein the gather accelerated address space is a virtual address space. Element 4: wherein the control logic is located in a base layer of the set of one or more stacked memory chips. Element 5: wherein one or more gather instructions of the gather operation are executed asynchronously to other instructions performed by the control logic. Element 6: wherein the byte chunk size can be one or more of 1 Byte (B), 2B, 4B, 8B, or 16B. Element 7: wherein the gather operation includes the byte chunk size to be utilized. Element 8: wherein the processing unit is a graphics processing unit (GPU). Element 9: wherein the gather operation specifies using a set of per-stack local addresses, where each memory stack utilizes the set of per-stack local addresses and the L1 cache utilizes the set of per-stack local addresses to perform merges of the requested data. Element 10: wherein the merged requested data is stored in the respective memory stack allocated to a same stack slice as the SM at a per-stack local address in the set of per-stack local addresses. Element 11: wherein the processing unit requests updated requested data and the updated requested data is stored in the gather accelerated address space. Element 12: wherein the one or more memory stacks is at least two memory stacks each communicatively coupled to the processing unit, and the requested data has been stored across the at least two memory stacks. Element 13: wherein the gather operation specifies a gather algorithm for the one or more memory stacks to utilize to combine more than one memory sector into one memory sector. Element 14: wherein the gather operation utilizes a progressive sum algorithm or a multiplication algorithm. Element 15: wherein the gather accelerated address space is allocated as a region from within a virtual address space. Element 16: where the byte chunk size allows for each portion of the requested data to be in contiguous memory sectors. Element 17: wherein the gather operation is implemented using one or more gather instructions.

1. A memory apparatus, comprising:
a set of one or more stacked memory chips, containing at least two memory chips; and
a control logic, operable to direct operation of the set of one or more stacked memory chips and to communicate with at least one processing unit, copy requested data using a gather operation, requested by the at least one processing unit, from the set of one or more stacked memory chips to a gather accelerated address space, the requested data is communicated to the at least one processing unit using the gather accelerated address space, where the gather operation aligns the requested data to a byte chunk size expected by the at least one processing unit and copies at least two non-contiguous byte segments corresponding to the requested data.

2. The memory apparatus as recited in claim 1, wherein the set of one or more stacked memory chips are dynamic random-access memory (DRAM) chips.

3. The memory apparatus as recited in claim 1, wherein the processing unit is a graphics processing unit (GPU), a central processing unit (CPU), or a single instruction, multiple data processing unit (SIMD).

4. The memory apparatus as recited in claim 1, wherein the gather accelerated address space is a virtual address space.

5. The memory apparatus as recited in claim 1, wherein the control logic is located in a base layer of the set of one or more stacked memory chips.

6. The memory apparatus as recited in claim 1, wherein one or more gather instructions of the gather operation are executed asynchronously to other instructions performed by the control logic.

7. The memory apparatus as recited in claim 1, wherein the byte chunk size can be one or more of 1 Byte (B), 2B, 4B, 8B, or 16B.

8. A processing unit, comprising:
a streaming multiprocessor (SM) operable to initiate a gather operation;
at least two L2 caches, wherein each L2 cache is communicatively coupled to a different memory stack, where each L2 cache receives requested data from a respective memory stack utilizing the gather operation, and the requested data is retrieved from at least two non-contiguous byte segments where zeros are used to fill non existing data in the requested data according to a byte chunk size; and
an L1 cache communicatively coupled to the at least two L2 caches and the SM, wherein the L1 cache merges the requested data received from each of the at least two L2 caches into a merged requested data and communicates the merged requested data to the SM.

9. The processing unit as recited in claim 8, wherein the gather operation includes the byte chunk size to be utilized.

10. The processing unit as recited in claim 8, wherein the processing unit is a graphics processing unit (GPU).

11. The processing unit as recited in claim 8, wherein the gather operation specifies using a set of per-stack local addresses, where each memory stack utilizes the set of per-stack local addresses and the L1 cache utilizes the set of per-stack local addresses to perform merges of the requested data.

12. The processing unit as recited in claim 11, wherein the merged requested data is stored in the respective memory stack allocated to a same stack slice as the SM at a per-stack local address in the set of per-stack local addresses.

13. A system, comprising:
one or more memory stacks, wherein each of the one or more memory stacks have at least two memory chips and a control logic capable of directing operations of the memory stack; and
a processing unit communicatively coupled to the one or more memory stacks, capable of initiating a gather operation to at least one of the one or more memory stacks, wherein the gather operation informs the at least one of the one or more memory stacks to return requested data, the requested data is stored across more than one memory sector of the at least one of the one or more memory stacks, the requested data is mapped into a gather accelerated address space where non-contiguous memory sectors containing the requested data are mapped according to a byte chunk size, and the requested data is communicated to the processing unit from the gather accelerated address space.

14. The system as recited in claim 13, wherein the processing unit requests updated requested data and the updated requested data is stored in the gather accelerated address space.

15. The system as recited in claim 13, wherein the one or more memory stacks is at least two memory stacks each communicatively coupled to the processing unit, and the requested data has been stored across the at least two memory stacks.

16. The system as recited in claim 13, wherein the gather operation specifies a gather algorithm for the one or more memory stacks to utilize to combine more than one memory sector into one memory sector.

17. The system as recited in claim 16, wherein the gather operation utilizes a progressive sum algorithm or a multiplication algorithm.

18. The system as recited in claim 13, wherein the gather accelerated address space is allocated as a region from within a virtual address space.

19. The system as recited in claim 13, where the byte chunk size allows for each portion of the requested data to be in contiguous memory sectors.

20. A method, comprising:
initiating a gather operation at a streaming multiprocessor (SM) for requested data, wherein the requested data is stored in at least two non-contiguous memory sectors of a set of one or more stacked memory chips;
receiving the gather operation at one or more sets of stacked memory chips;
gathering the requested data into a gather accelerated address space of the one or more sets of stacked memory chips, wherein the gather accelerated address space is a virtual address space backed by physical memory, and at least some unneeded memory sectors are not copied into the gather accelerated address space;
aligning the requested data in the gather accelerated address space according to a byte chunk size used by the SM; and
communicating the requested data to the SM.

21. The method as recited in claim 20, wherein the gather operation is implemented using one or more gather instructions.
